(19) United States
(12) Patent Application Publication
(10) Pub. No.: US 2004/0181446 A1
(43) Pub. Date: Sep. 16, 2004

(54) Method, system and apparatus for managing workflow in a workplace

(76) Inventor: Michael E. Vance, Marietta, GA (US)

Correspondence Address: CANTOR COLBURN, LLP, 55 GRIFFIN ROAD SOUTH, BLOOMFIELD, CT, 06002

(21) Appl. No.: 10/387,670

(22) Filed: Mar. 13, 2003

(51) Int. Cl. G06F 17/60

(52) U.S. Cl. 705/11

(57) ABSTRACT

A method of managing workflow in a workplace includes defining the business strategy, identifying the customer needs relating to the business strategy, and defining the work elements responsive to the customer needs and the business strategy. A determination is made as to whether the work elements are to include an improvement initiative or not. If an improvement initiative is to be included, then the improvement initiative is managed, along with the management of work elements for improved process performance. If an improvement initiative is not to be included, then the work elements are managed for sustained process performance.

### BACKGROUND OF THE INVENTION

The present disclosure relates generally to a method for continually managing workflow in a workplace, and particularly to a method for continually identifying improvement initiative opportunities and associated risks for sustained performance within a workplace.

A workplace, such as a small or large multifunctional business, typically operates under a managed workflow to yield a product or service for an end user, the customer. To better structure the workflow, each function of the multifunctional business typically creates functionally oriented programs and sub-programs and staffs those programs and sub-programs accordingly with program leaders or process owners. The resulting structured functional workflows are then managed according to sets of guidelines established by the respective functions within the business. To assist in the management of various structured workflows, various tools have emerged, including project schedulers, resource planners, budget planners, and Design For Six Sigma (DFSS) methodologies (for example, Design-Measure-Analyze-Improve-Control (DMAIC), Failure Mode Effects Analysis (FMEA), Design of Experiments (DOE), Quality Function Deployment (QFD), Process Mapping, and Monte Carlo (MC)). While these management tools have been shown to be popular through their use at the project level where the project typically has a defined start and end point, they have also become quite complex, and are difficult to implement at the business level where the business as a whole operates without a defined end point. Since a typical business is generally concerned with minimizing cost and maximizing revenue while maintaining customer satisfaction, it would be beneficial to have a management tool that can assist in the management of an entire business at the business level and operate on a continual basis.

### SUMMARY OF THE INVENTION

In one embodiment, a method of managing workflow in a workplace is disclosed. At the onset, the business strategy is defined, the customer needs relating to the business strategy are identified, and the work elements responsive to the customer needs and the business strategy are defined. A determination is made as to whether the work elements are to include an improvement initiative or not. If an improvement initiative is to be included, then the improvement initiative is managed, along with the management of work elements for improved process performance. If an improvement initiative is not to be included, then the work elements are managed for sustained process performance.

In another embodiment, a system for managing workflow in a workplace is disclosed. The system includes a workplace strategy and metrics component that is configured to define and establish a workplace strategy and workplace metrics. A processes component is configured to define and establish core and enabling processes relating to the strategy and metrics. A subprocesses component is configured to define and establish subprocesses relating to the core and enabling processes. A mapping component is configured to map the processes relating to the established subprocesses, and process output and work activity output components are configured to define and establish process output variables relating to the mapped processes. An analysis component is configured to analyze process performance relating to the mapped processes and to identify an area to sustain current performance or an area to improve current performance. A management component is configured to manage and conduct actionable initiatives defined by sustained process performance initiatives and improved performance initiatives relating to the mapped processes and the defined strategy and metrics, and a scaling component is configured to scale the completed improved performance initiatives and the sustained process performance initiatives.

In a further embodiment, a computer program product for continually managing workflow in a workplace and for continually identifying and managing workplace improvement initiatives is disclosed. The product includes a storage medium, readable by a processing circuit, that stores instructions (referred to generally as a program) for execution by the processing circuit. The program receives and displays improvement initiative opportunity data, including data relating to subjective questions and data relating to financial considerations, stores the improvement initiative opportunity data in a dashboard, calculates a score based on the dashboard data, communicates the score and financial data to another dashboard, communicates the score to a displayable mapping dashboard, and displays the first and second dashboards. The program also communicates dashboard information to a displayable scorecard for management consideration.

### BRIEF DESCRIPTION OF THE DRAWINGS

Referring to the exemplary drawings wherein like elements are numbered alike in the accompanying Figures:

FIG. 1 depicts an exemplary method for implementing an embodiment of the invention;

FIG. 2 depicts further detail of a portion of the exemplary method of FIG. 1;

FIG. 3 depicts an exemplary operational structure for implementing the method of FIG. 1;

FIG. 4 depicts an exemplary timeline of processes associated with three exemplary operational levels for implementing the method of FIG. 1;

FIG. 5 depicts an exemplary timeline of processes and sub-processes for a first exemplary operational level depicted in FIG. 4;

FIG. 6 depicts an exemplary timeline of processes and sub-processes for a second exemplary operational level depicted in FIG. 4;

FIG. 7 depicts an exemplary timeline of processes and sub-processes for a third exemplary operational level depicted in FIG. 4;

FIGS. 8A-8E depict an exemplary dashboard for use in accordance with an embodiment of the invention;

FIG. 9 depicts another exemplary dashboard for use in accordance with an embodiment of the invention;

FIG. 20 depicts an exemplary process map for use in accordance with an embodiment of the invention;

FIGS. 11A-11C depict an exemplary scorecard for use in accordance with an embodiment of the invention;

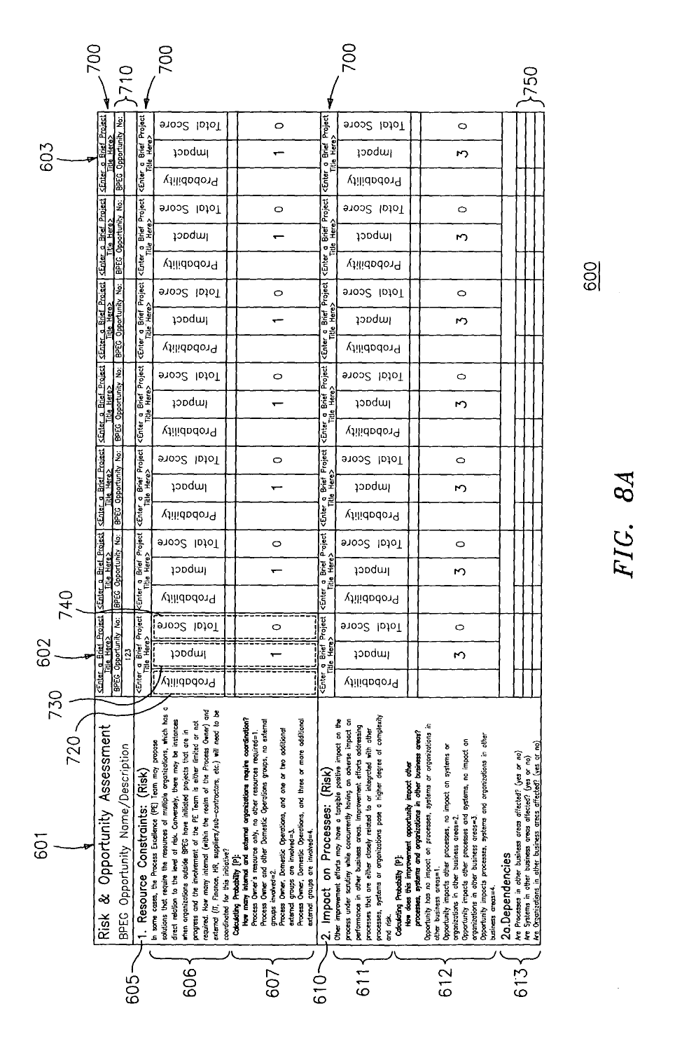

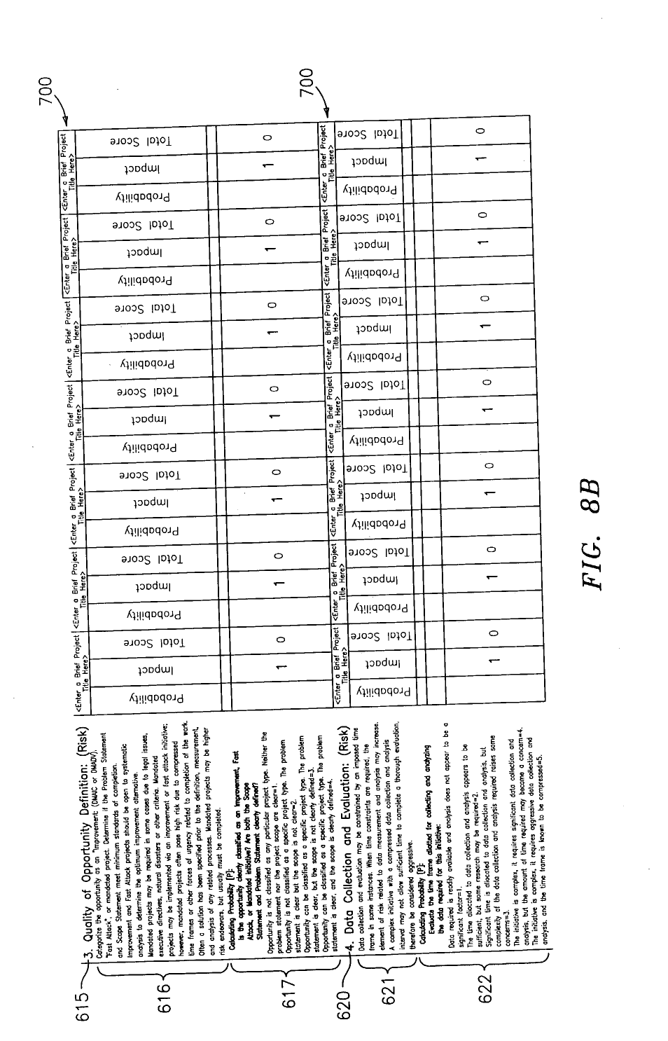

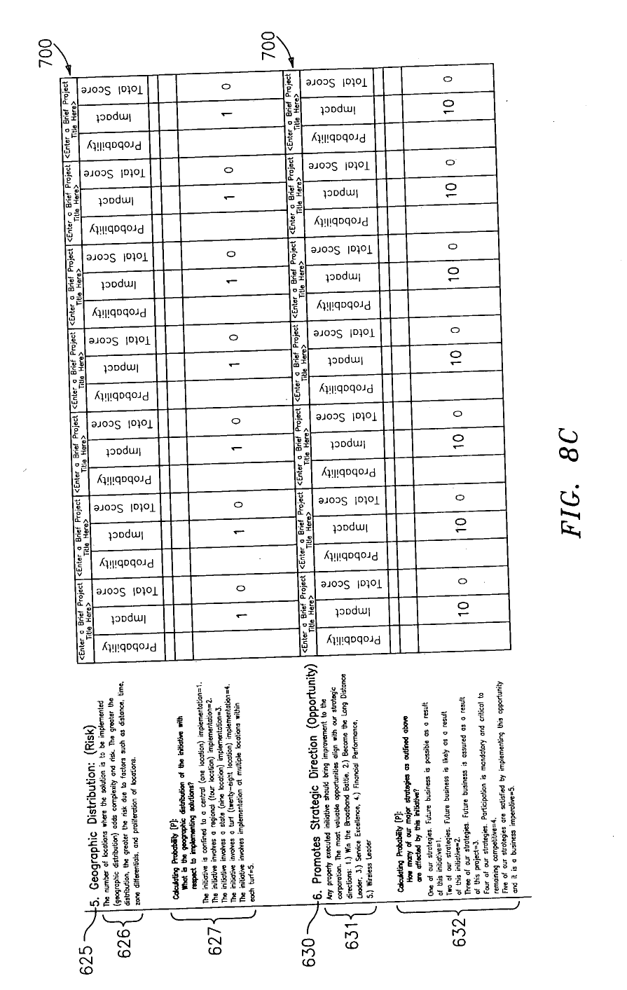

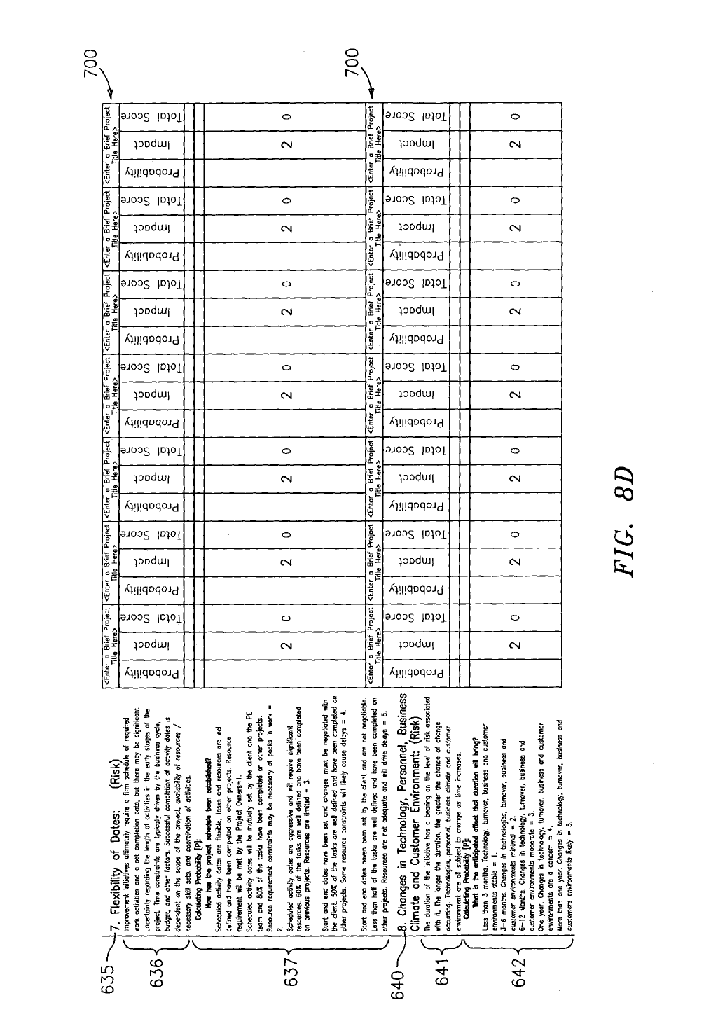

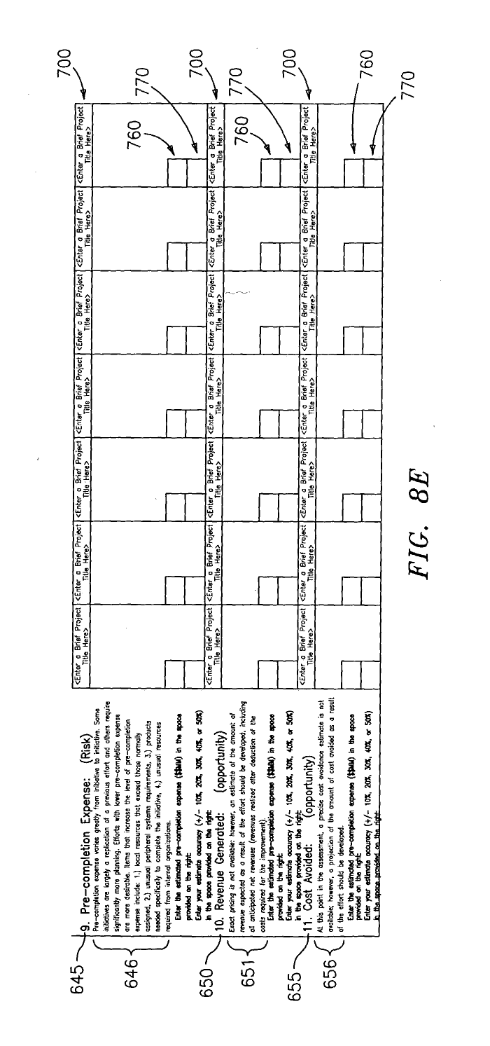

FIG. 12 depicts an exemplary architecture for the dashboards, process map, and scorecard depicted in FIGS. 8A-8E, 9, 10, and 11A-11C; and

FIG. 13 depicts an exemplary computer system for implementing an embodiment of the invention.

### DETAILED DESCRIPTION OF THE INVENTION

An embodiment of the present invention provides a method for continually managing workflow elements within a business, or workplace generally. In such a method, not only are improvement initiatives and associated risks continually identified, analyzed, rated, prioritized, selected, and communicated to controlling authorities within the business, but also the workflow elements are managed for sustained process performance. In this manner, continual improvement initiatives and sustained process performance initiatives are managed while balancing operational cost, revenue and customer satisfaction.

An embodiment of the invention involves the execution of a set of methods and associated tools needed to manage a cross-functional end-to-end process, with the end result simultaneously satisfying the customers' needs for effective process performance and the business' need for efficiency. Implementation of the herein disclosed invention provides the following characteristics to the business:

Develop a performance based process orientation to drive team focus, ownership and collaboration;

Focus on customer requirements and how to consistently meet those requirements—Improve customer experience;

Integrate performance based measurement into process design and execution;

Enable improved business decision making—Correctly identify and respond to the measures that matter;

Maximize revenue enhancement and cost reduction;

Link Business Strategy to work force execution through a proactive management approach; and

Know how your processes perform and then use that knowledge as a competitive advantage.

As an overview, an embodiment of the invention includes nine highly interrelated process management activities:

1. Define Strategy and Key Business Metrics

2. Define and Establish Core and Enabling Processes

3. Define and Establish Sub Processes

4. Map the Process

5. Define Process Output Variables

6. Define Work Activity Output Variables

7. Analyze the Process

8. Manage and Conduct Improvement Initiatives

9. Scale Completed Improvements and Sustain Process Performance

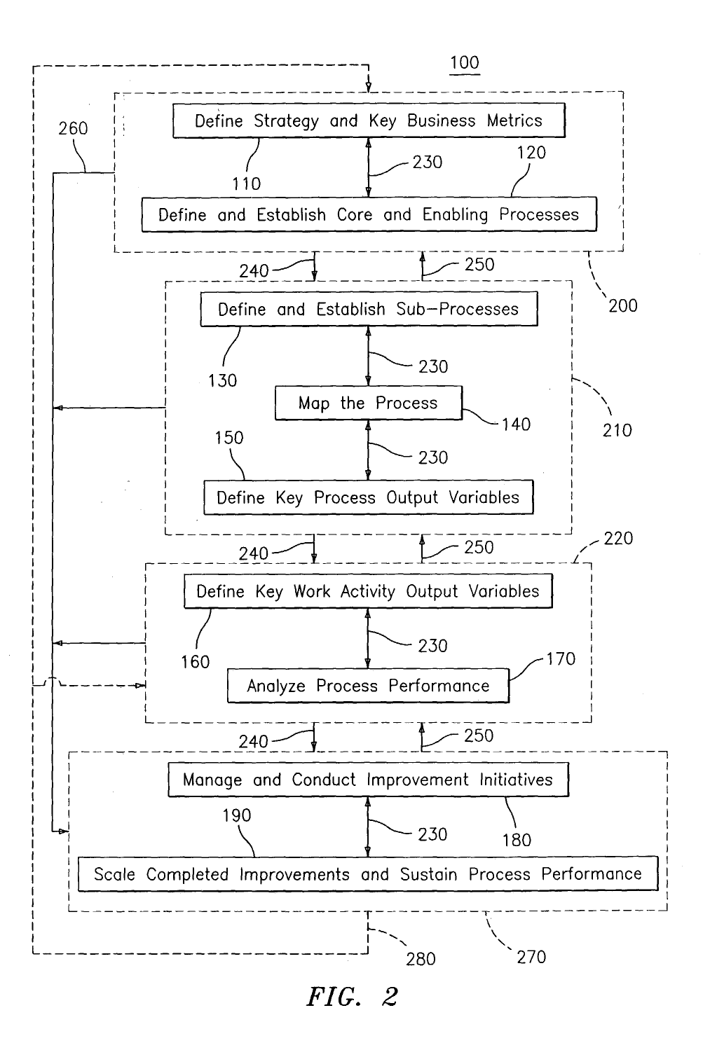

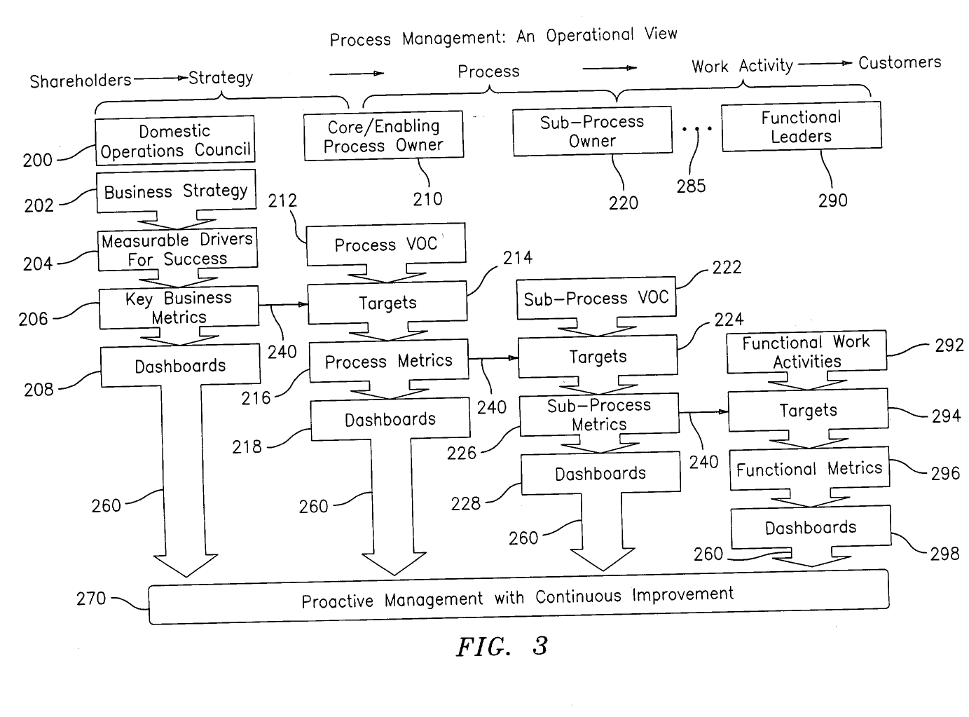

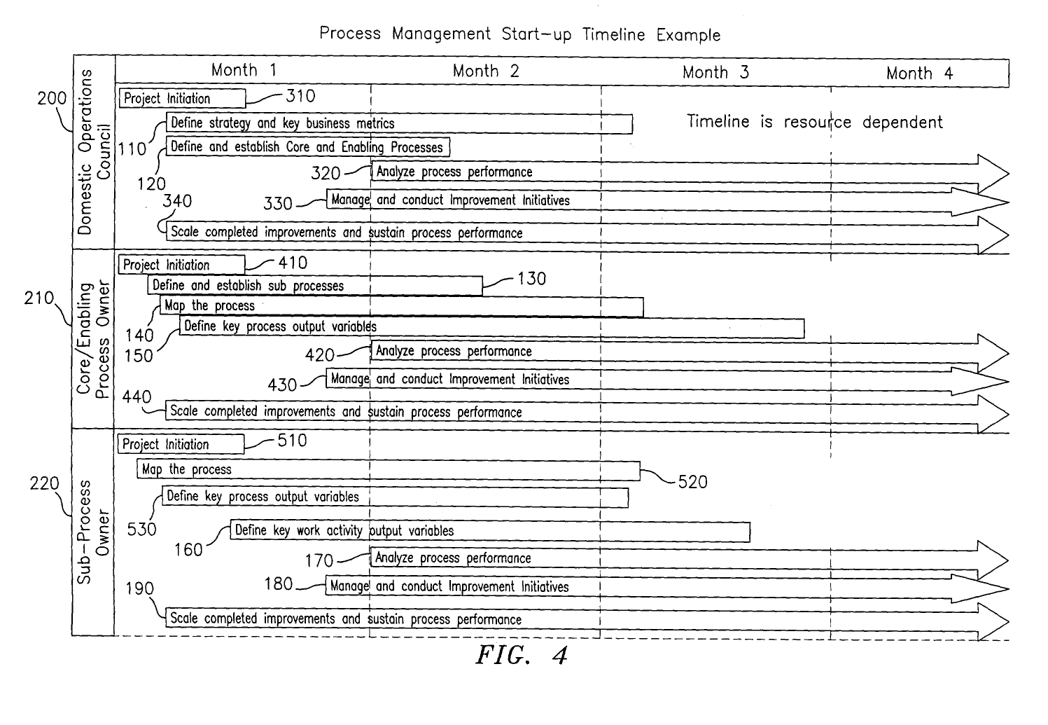

Four distinct levels of governance within the workplace work together to complete the nine activities of process management, which include: Domestic Operations Council; Core/Enabling (C/E) Process Owner; Sub-Process Owner; and, Functional Leader. The Sub-Process Owner and Functional Leader are the levels at which the physical work of the process is accomplished, and as such, both work within the sub-process realm of activities. Both the governance levels and there relation to the nine process management activities are represented in FIGS. 2-7. FIG. 2 depicts a process flow for the nine activities, FIG. 3 depicts an operational view of the four levels of governance, and FIGS. 4-7 depict timelines for the detailed outputs of each activity for each level of governance. The bullet points below the activity headings in the timelines represent those activities that need to be accomplished in order to achieve the intent of the nine activities.

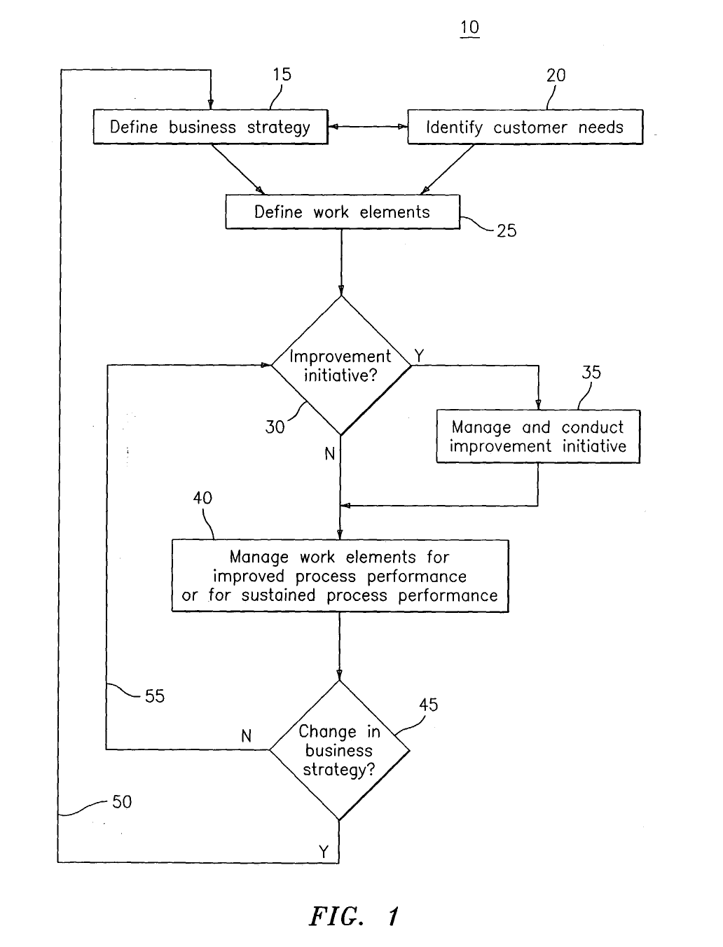

Referring now to FIG. 1, an exemplary embodiment of a method 10 in accordance with the invention is depicted. Method 10 provides an overview of the methodology of the present invention and begins with the general work activities of: defining the business strategy 15; identifying the customer needs 20; and, defining the work elements 25 that are needed to meet the customer needs while satisfying the business strategy. Defining the work elements 25 provides a link to the governance of the work elements, which, as discussed below, is instrumental in sustaining process performance. After block 25, a determination 30 is made whether an improvement initiative should be included into the work elements, or whether the present process is performing satisfactorily and needs to be managed for sustained process performance. If an improvement initiative is deemed appropriate, then the method 10 passes to block 35 where the improvement initiative is managed. After block 35, or if an improvement initiative is deemed not appropriate, the method 10 passes to block 40 where the defined work elements are managed for either improved process performance or sustained process performance. After block 40, the method 10 continues to block 45 where two continuous feedback loops 50, 55 are encountered. At block 45, a determination is made whether a change in business strategy is appropriate. If yes, then the method 10 passes to feedback loop 50, where the workflow is redirected back to block 15 where the appropriate governing body defines a modified business strategy 15. If no, then the method 10 passes to feedback loop 55, where the workflow is redirected back to block 30 where the appropriate governing body reevaluates whether it is now appropriate to consider an improvement initiative. The nested feedback loop arrangement of method 10 provides a management methodology for continuously managing workflow in a workplace that accommodates both improvement initiatives and sustained process performance.

FIG. 2 is an exemplary embodiment of a method 100 in accordance with the invention, which depicts a higher level of detail of several elements of method 10 of FIG. 1, and includes the nine general work activities of: defining the business strategy and associated key business metrics 110; defining and establishing core and enabling processes 120 relating to the strategy and metrics of the business; defining and establishing subprocesses relating to the core and enabling processes 130; mapping the overall process relating to the subprocesses 140; defining the key process output variables 150 relating to the mapped process; defining the key work activity output variables 160 relating to the mapped process; analyzing process performance 170 of the mapped process; identifying, prioritizing, managing and conducting improvement initiatives 180 relating to the mapped process and the defined strategy and metrics; and, scaling completed improvements and sustaining process performance 190. Each work activity 110-190 not only defines a step in the management methodology 100, but also represents discrete components of a controlling authority within the business that controls the respective activity. For example, numeral 110 not only represents the work activity of defining the business strategy and associated key business metrics 110, but also represents the workplace strategy and metrics component that controls that activity, and similarly for each of the other work activities 120-190.

As discussed above, method 100 of FIG. 2 depicts a higher level of detail for several elements in method 10 of FIG. 1. For example: element 15 of method 10 is expanded into elements 110, 120, 130, and 140; element 20 is depicted with further detail as element 150; element 25 is depicted with further detail as element 160; element 30 is depicted with further detail as element 170; element 35 is depicted with further detail as element 180; and, element 40 is depicted with further detail as element 190. The feedback loops 50, 55 are depicted as feedback loop 280 shown in broken line format. Further details relating to method 100 of FIG. 2 are discussed below.

On the operational component level, best seen by referring to FIGS. 1 and 2, work activity associated with numerals 110 and 120 generally fall under the controlling authority of the domestic operations council (DOC) 200, work activity associated with numerals 130-150 generally fall under the controlling authority of the core/enabling process owner (C/E-PO) 210, work activity associated with numerals 160-170 generally fall under the controlling authority of the sub-process owner (SPO) 220, and work activity associated with numerals 180-190 are work activities common to all components. Communication within an operational component is depicted by path 230, and communication between operational components is depicted by paths 240, 250. Communication path 240 is primarily indicative of both the flow of information and the direction of authoritative control, while communication path 250 is primarily indicative of the flow of information. Communication path 260 indicates a common communication link from the work activities within blocks 200, 210, and 220 of FIG. 1, to the work activities within block 270 of FIG. 1. The combined work activities of 180, 190 are represented as block 270 in FIGS. 1 and 2, which is also referred to as proactive management with continual improvement in FIG. 3. Communication path 280 indicates a continual feedback loop which enables information to flow back to the domestic operations council 200 from each of the operational components 200, 210, 220 after completion of work activities 180, 190, thereby enabling proactive management, continual process improvement, and sustained process performance within the business. Process 100 with feedback loop 280 depicts a continual process for continually exercising (i.e., repeating) the processes and subprocesses embedded within work activities 110-190. In an embodiment, feedback loop 280 is exercised on an annual basis.

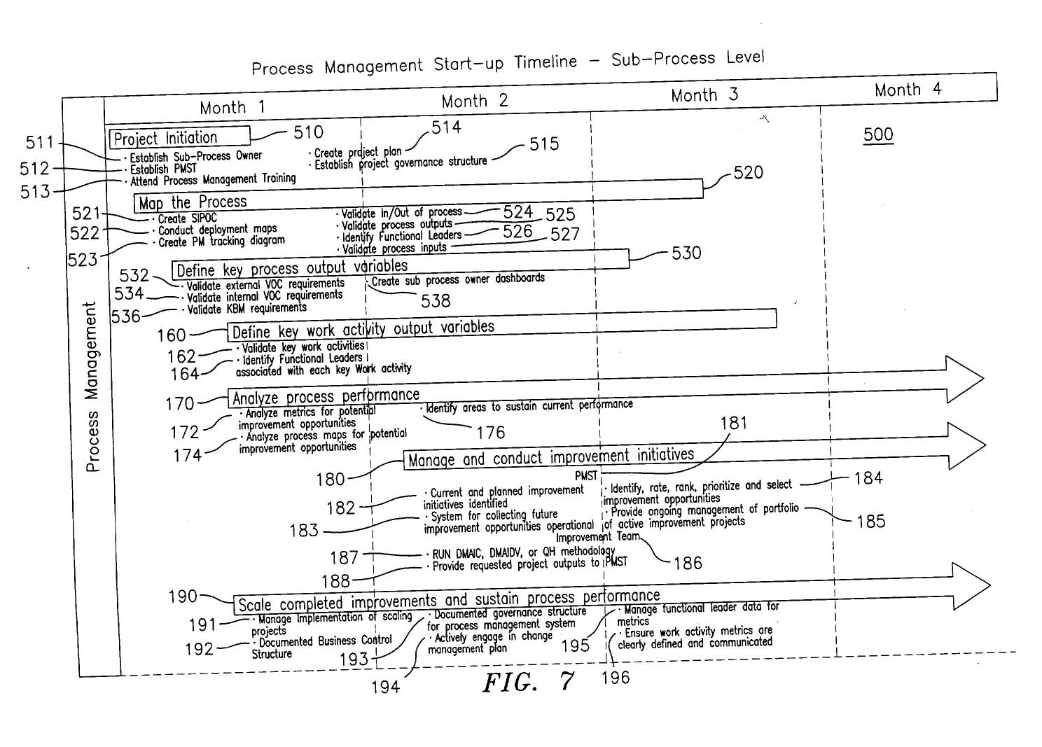

Referring now to FIG. 3, the operational component levels of DOC 200, C/E-PO 210, and SPO 220 are depicted with reference to the functional continuum from shareholders to customers. The operational component level of functional leader (FL) 290 is considered to be a subset of the SPO operational component level 220, as depicted by the ellipsis 285, and may include one or more FLs 290 and one or more individual workers. The SPO 220 is responsible for defining the key work activity output variables 160 and analyzing the process performance 170, while the FL 290 is responsible for specifically carrying out the key work activities defined by SPO 220. Each operational component 200, 210, 220, 290 has a defined set of operational responsibilities. The set of operational responsibilities for DOC 200 includes: defining the business strategy 202 and defining the key business metrics 206, also represented by 110 in FIG. 1; defining measurable drivers for success 204; and, establishing, managing and reporting the metric dashboards 208. A dashboard is described generally as a visual tool for communicating measurable elements, the metrics, relating to a particular activity, such as a project for example. An example of a dashboard for use in accordance with an embodiment of the invention is discussed below in reference to FIGS. 8A-7E. The set of operational responsibilities for C/E-PO 210 includes: defining the VOC (Voice Of the Customer) process 212, also represented by 130 in FIG. 1; defining the process targets 214, also represented by 150 in FIG. 1; defining the process metrics 216; and, establishing, managing and reporting the process metric dashboards 218, also represented by 140 in FIG. 1. The term Voice Of the Customer (VOC) refers to the collection of items that are of concern or interest to the customer, and are typically used in defining the customer critical to quality (CTQ) items. The set of operational responsibilities for SPO 220 includes: defining the VOC sub-process 222, defining the sub-process targets 224, defining the sub-process metrics 226, and, establishing, managing and reporting the sub-process metric dashboards 228. The set of operational responsibilities for FLs 290 includes: defining the functional work activities 292, defining the functional targets 294, defining the functional metrics 296, and establishing, managing and reporting the functional dashboards 298. The operational responsibilities for FL 290 are similar to the operational responsibilities of SPO 220, but at the implementation level.

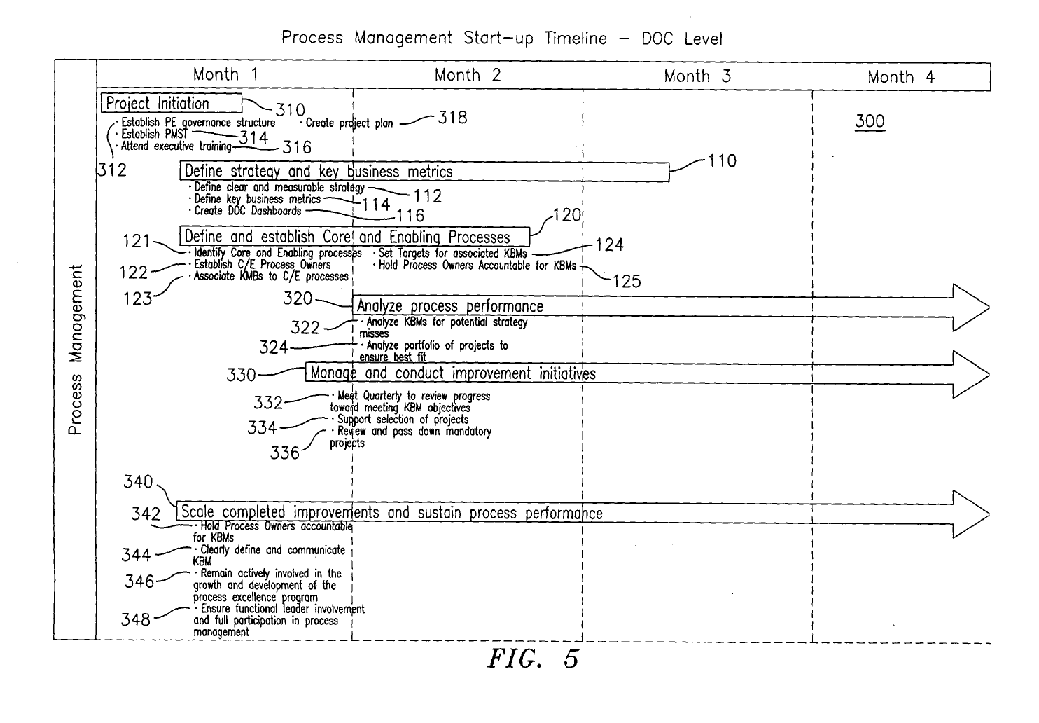

Exemplary process timelines 300, 400, 500 for the DOC 200, C/E-PO 210, and SPO 220 operational components, respectively, are depicted in FIGS. 3-6, with FIG. 4 depicting an overview for each timeline, and FIGS. 4-6 depicting further detail for each timeline. Each timeline 300, 400, 500 shows the respective process management elements along the y-axis and the time scale along the x-axis. While the time scale is depicted in monthly increments, it is understood that any time increment may be used as appropriate for the particular project and business. Each timeline has several process elements, such as 310 in FIG. 5, with each process element having several sub-process elements, such as 312 in FIG. 5. The process and sub-process elements provide the management framework for the members of each respective operational component. Several process elements have start and end times, while other process elements have start times with no particular end time since they are intended to play a continual role in the management process herein described. Exemplary start and end times are depicted in FIGS. 4-6 by the beginning and end of the process element header, however, the artisan will appreciate that the start and end time for each process element may vary depending on the particular project at hand. The order of the process elements indicates generally that a prior process element must commence before a subsequent process element can begin. However, once a process element has been initiated, the prior and subsequent process elements may coexist, as depicted by the parallel coexistence in the timelines of FIGS. 3-6.

Referring now to FIG. 5, an exemplary DOC timeline 300 begins, as do timelines 400, 500, with project initiation 310, which has four sub-elements: establish PE (Process Excellence) governance structure 312 relating to the project at hand; establish a process management support team (PMST) 314 for support in implementing the project plan; attend executive training 316 relating to the implementation of the methodology described herein; and, create the project plan 318 for the project at hand. The PE governance structure 312 is the set of responsibilities and activities that are to be agreed upon for each level of the process. Project initiation 310 provides a management tool whereby DOC 200 defines for the DOC operational level the structure of the project at hand. The second process element is define business strategy and key business metrics 110, shown also in FIG. 1, which has three sub-elements: define a clear and measurable strategy 112; define the key business metrics 114; and, create the DOC dashboards 116. Generally, process element 110 doesn't begin until some project has been initiated at process element 310, however, process element 110 may coexist with process element 310 by coexisting with the several process sub-elements 312-318. The second process element 110 clearly defines the strategy of the business and how the business is to measure itself. The third process element is define and establish the core and enabling processes 120, shown also in FIG. 1, which has five sub-elements: identify the core and enabling processes 121 required for the project, that is, what core processes are available within the business and what processes are required to enable completion of the project at hand; establish C/E-POs 122, which are personnel resources that are responsible for driving the core and enabling processes; associate KBMs (Key Business Metrics) to the C/E processes 123; set targets for associated KBMs 124, which are measurable work elements; and, hold process owners (POs) accountable for KBMs 125, thereby establishing process accountability. The fourth process element is analyze process performance 320, which has two sub-elements: analyze KBMs for potential strategy misses 322; and, analyze portfolio of projects to ensure best fit 324. Here, project management tools may be used to analyze projected performance against plan, and to establish elements for a metrics dashboard. As indicated by the absence of a defined end time, process element 320 is intended to have continual involvement in the project, thereby indicating continual analysis for continual improvement and sustained process performance. The fifth process element, also absent a defined end time, is manage and conduct improvement initiatives 330, which has three sub-elements: meet quarterly to review progress toward meeting KBM objectives 332; support selection of projects 334; and, review and pass down mandatory projects 336. Here, DOC 200 exerts its authority over subordinate operational levels with regard to the selection and management of improvement initiatives. The sixth process element, also absent a defined end time, is scale completed improvements and sustain process performance 340, which has four sub-elements: hold process owners accountable for KBMs 342; clearly define and communicate KBM 344; remain actively involved in the growth and development of the process excellence program 346; and, ensure functional leader involvement and full participation in process management 348. Here, the analysis of measurable elements are reviewed for disposition and communication to members of the DOC 200 operational level and to members of the subordinate C/E-PO 210 operational level. Process elements 310, 110, 120, 320, 330, and 340, along with the associated process sub-elements, are implemented in concert with the operational responsibilities 202, 204, 206, 208, discussed above in reference to DOC 200 in FIG. 3.

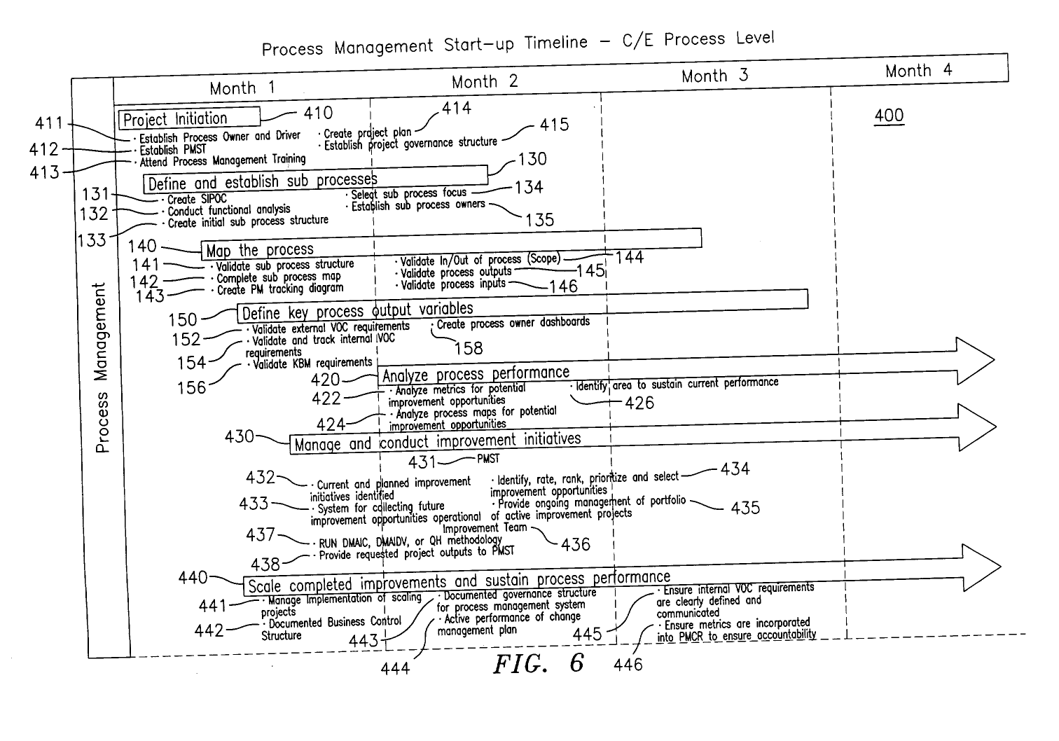

Referring now to FIG. 6, an exemplary C/E-PO timeline 400 begins with project initiation 410, which has five sub-elements: establish process owner and driver 411, which determines the primary resource for driving this initiative; establish PMST 412; attend process management training 413 relating to the implementation of the methodology described herein; create project plan 414 for the initiative at hand; and, establish project governance structure 415 to manage the initiative at hand. Here, C/E-PO 210 defines for the C/E-PO operational level the structure of the project at hand. The second process element is define and establish sub-processes 130, shown also in FIG. 1, which has five sub-elements: create supplier-input-process-output-customer (SIPOC) list 131 to help identify the various sub-processes; conduct functional analysis 132 relating to the initiative at hand; create initial sub-process structure 133; select sub-process focus 134; and, establish sub-process owners 135. Here, the sub-processes for the improvement initiative are established for subsequent communication to the SPO 220. The third process element is map the process 140, shown also in FIG. 1, which has six sub-elements: validate sub-process structure 141; complete sub-process map 142; create a Process Management (PM) tracking diagram 143; validate In/Out of process (scope) 144; validate process outputs 145; and, validate process inputs 146. The sub-element validate In/Out of process 144 involves a validation of the start and stop points of each process element with respect to related process elements. The start and stop points of each process element should permit all activities of the process element to be covered in the process, hence the desire for validation. The sub-elements validate process outputs 145 and validate process inputs 146 relate to the validation of the associated metrics and not to the activity itself. By mapping the process, the C/E-PO 210 can visually communicate the various process elements to the SPO 220. The fourth process element is define key process output variables 150, shown also in FIG. 1, which has four sub-elements: validate external VOC requirements 152; validate and track internal VOC requirements 154; validate KBM requirements 156; and, create process owner dashboards 158 for the management and communication of related metrics. Defining the key process output variables enables a clear understanding of the process metrics for subsequent dashboarding. The fifth process element is analyze process performance 420, which has three sub-elements: analyze metrics for potential improvement opportunities 422; analyze process maps for potential improvement opportunities 424; and, identify areas to sustain current performance 426. Results from the analysis are entered into a metrics dashboard, discussed below in reference to FIGS. 8A-7E. The sixth process element is manage and conduct improvement initiatives 430, which includes two functional groups: process management support team (PMST) 431; and, improvement team 432. The PMST 431 is responsible for four sub-elements: identify current and planned improvement initiatives 432; establish system for collecting future operational improvement opportunities 433; identify, rate, rank, prioritize, and select improvement opportunities 434; and, provide ongoing management of portfolio of active improvement projects 435. The improvement team 436 is responsible for two sub-elements: run DMAIC (Design, Measure, Analyze, Improve, Control), DMADV (Design, Measure, Analyze, Design, Validate), or QH (Quick Hit) methodologies 437, which utilize known six-sigma process management techniques; and, provide requested project outputs to PMST 438. A QH methodology 437 relates to an opportunity where the business realizes a value from the opportunity in a short period of time, where a short period of time is defined by the type of business pursuing the opportunity and seeking the value. The prioritized outcome of process element 430 provides a clearer understanding of where the improvement initiative opportunities are. The seventh process element is scale completed improvements and sustain process performance 440, which has six sub-elements: manage implementation of scaling projects 441; document business control structure 442; document governance structure for process management system 443; active performance of change management plan 444; ensure internal VOC requirements are clearly defined and communicated 445; and, ensure metrics are incorporated into PMCR (Performance Management Commitment Results) tracking to ensure accountability 446. Here, completed improvement initiatives are compared against plan for sustained process performance.

As indicated in FIG. 6, process elements 420, 430, 440 depict an absence of a defined end time, which, as discussed above, indicates that these process elements are intended to be continually involved in the management of the improvement process. Process elements 410, 130, 140, 150, 420, 430, and 440, along with the associated process sub-elements, are implemented in concert with the operational responsibilities 212, 214, 216, 218, discussed above in reference to the C/E-PO 210 in FIG. 3.

Referring now to FIG. 7, an exemplary SPO timeline 500 begins with project initiation 510, which has five sub-elements: establish sub-process owner 511; establish PMST 512; attend process management training 513 relating to the implementation of the methodology described herein; create project plan 514; and, establish project governance structure 515. Here, SPO 220 defines for the SPO operational level the structure of the project at hand. The second process element is map the process 520, which has seven sub-elements: create SIPOC list 521; create deployment maps 522 that identify on a single map functions associated with activities and the order in which the activities occur; create PM tracking diagram 523; validate In/Out of process 524; validate process outputs 525; identify functional leaders 526; and, validate process inputs 527. Here, the SPO 220 provides a process map for implementation by the FL 290. The third process element is define key process output variables 530, which has four sub-elements: validate external VOC requirements 532; validate internal VOC requirements 534; validate KBM requirements 536; and, create sub-process owner dashboards 538. Here, the process output variables are clearly identified for actionable implementation by the FL 290. The fourth process element is define key work activity output variables 160, shown also in FIG. 1, which has two sub-elements: validate key work activities 162; and, identify functional leaders associated with each key work activity 164. Here, the SPO 220 defines the functional work activities for implementation by the FL 290. The fifth process element is analyze process performance 170, shown also in FIG. 1, which has three sub-elements: analyze metrics for potential improvement opportunities 172; analyze process maps for potential improvement opportunities 174; and, identify areas to sustain current performance 176. Process performance analysis provides the necessary input into the metric dashboards that are used to manage sustained process performance. The sixth process element is manage and conduct improvement initiatives 180, shown also in FIG. 1, which includes two functional groups: the PMST 181; and, the improvement team 186. The PMST 181 is responsible for four sub-elements: identify current and planned improvement initiatives 182; establish system for collecting future operational improvement opportunities 183; identify, rate, rank, prioritize and select improvement opportunities 184; and, provide ongoing management of portfolio of active improvement projects 185. The improvement team 186 is responsible for two sub-elements: Run DMAIC, DMAIDV, or QH methodologies 187; and, provide requested project outputs to PMST 188. The seventh process element is scale completed improvements and sustain process performance 190, shown also in FIG. 1, which has six sub-elements: manage implementation of scaling projects 191; document business control structure 191; document governance structure for process management system 193; actively engage in change management plan 194; manage functional leader data for metrics 195; and, ensure work activity metrics are clearly defined and communicated 196.

As indicated in FIG. 7, process elements 170, 180, 190 depict an absence of a defined end time, which, as discussed above, indicates that these process elements are intended to be continually involved in the management of the improvement process. Process elements 510, 520, 530, 160, 170, 180, and 190, along with the associated process sub-elements, are implemented in concert with the operational responsibilities 222, 224, 226, 228, discussed above in reference to the SPO 220 in FIG. 3.

As shown in FIGS. 4-6, each operational component level 200, 210, 220 has the following process elements: analyze process performance (320, 420, 170); manage and conduct improvement initiatives (330, 430, 180); and, scale completed improvements and sustain process performance (340, 440, 190), which collectively provide the information necessary to dashboard the process metrics (see 208, 218, 228, 298, in FIG. 3), and provide input for the proactive management of the business thereby driving continual improvement (see 270 in FIG. 3). While it is known in the art that dashboards provide an aid for capturing, tracking, analyzing, and reporting various metrics involved in the management of the business, the type of information flow into and out of a dashboard in accordance with embodiments of this invention are not known in the art.

An example of a dashboard 600 for use in an embodiment of the invention is depicted in FIGS. 8A-7E. Dashboard 600 is primarily driven by the manage-and-conduct-improvement-initiatives process elements 430, 180 from the C/E-PO and SPO operational components, respectively, and is used for performing risk and opportunity (R/O) assessment analyses. A R/O assessment analysis enables a process owner to assess the viability of improvement initiative opportunities before developing a full project plan and proposal relating to a specific improvement initiative.

The first column 601 of dashboard 600 identifies eleven question categories that make up the R/O assessment questionnaire: resource constraints 605 (a risk factor); impact on processes 610 (a risk factor); quality of opportunity definition 615 (a risk factor); data collection and evaluation 620 (a risk factor); geographic distribution 625 (a risk factor); strategic direction 630 (an opportunity factor); flexibility of dates 635 (a risk factor); changes in technology, personnel, business climate, and customer environment 640 (a risk factor); pre-completion expense 645 (a risk factor); revenue generation 650 (an opportunity factor); and, cost avoidance 655 (an opportunity factor). Question categories 605, 610, 615, 620, 625, 630, 635, 640 relate to non-financial considerations, while question categories 645, 650, 655 relate to financial considerations. The non-financial categories 605-640 each include a descriptive paragraph (606 for category 605 for example) that poses a question to be answered, and a set of single statement answers (607 for category 605 for example) that are available for answering the question posed.

The second column 602 through nth-column 603 provide user-input locations for storing information relating to each improvement initiative opportunity, which is then used for subsequent analysis and disposition. For example, column 602 includes: entry blocks for entering a brief project title 700; entry blocks for entering an opportunity identification number 710; entry blocks for entering a user-selected probability score (P), depicted by dashed lines 720; identification blocks for identifying a pre-defined impact rating (I), depicted by dashed lines 730; and, display blocks for displaying the product of (P)*(I) (total score), depicted by dashed lines 740. While the entry blocks depicted by dashed lines 720, 730, 740, are depicted only at the intersection of column 602 and category 605, the artisan will appreciate that the same arrangement applies to the intersections of other columns and categories having the same general format. The selection of a single statement, from 607 for example, that best answers the question posed, from 606 for example, defines a numerical value (P) that is entered into block 720. Dashboard 600, being in spreadsheet form, is programmed to multiply the value of (P) from block 720 with the value of (I) from block 730 and to place the result, total score, into block 740. The pre-defined impact rating (I) may differ from business to business, and from project to project, and is therefore left as an adjustable variable. As shown in exemplary dashboard 600, the impact ratings (I) for the various categories are: (1) for categories 605, 615, 620, 625; (3) for category 610; (10) for category 630; and, (2) for categories 635, 640.

A subset of category 610 is a sub-category relating to dependencies 613, which asks whether: the processes in other business areas are affected; the systems in other business areas are affected; and, the organizations in other business areas are affected. The resulting yes or no answers are recorded at location 750 in dashboard 600.

The financial categories 645, 650, 655, include descriptive paragraphs 646, 651, 656, respectively, for describing the financial points of interest, entry blocks for estimating the dollar value 760 relating to the particular point of interest, and entry blocks for estimating the accuracy level 770 relating to the respective dollar values 760.

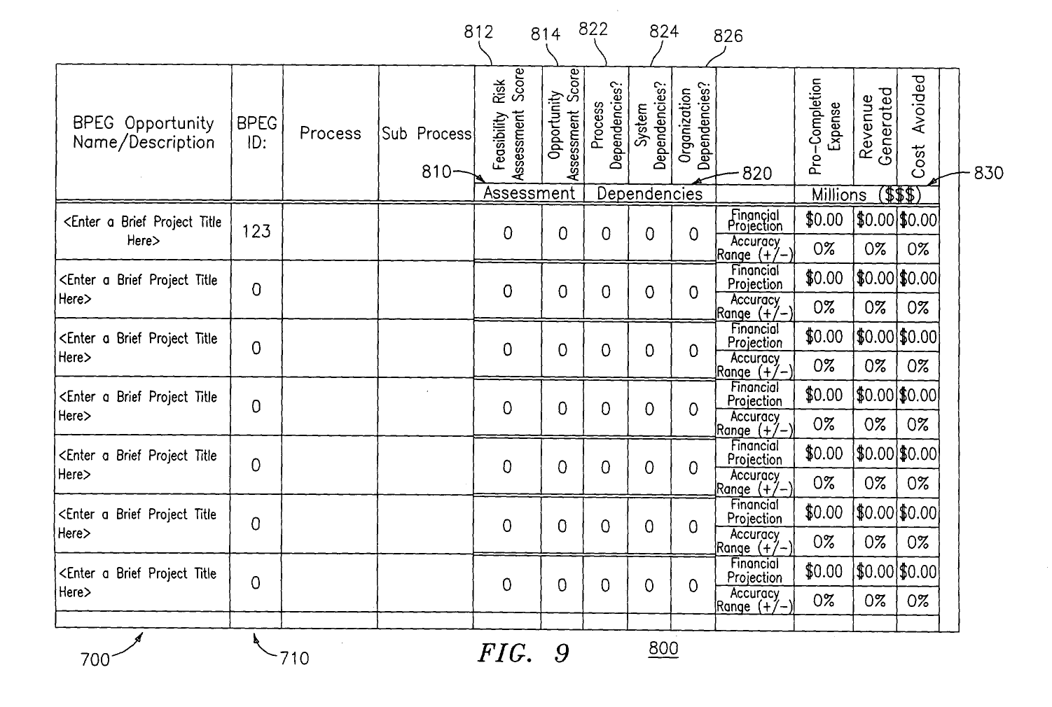

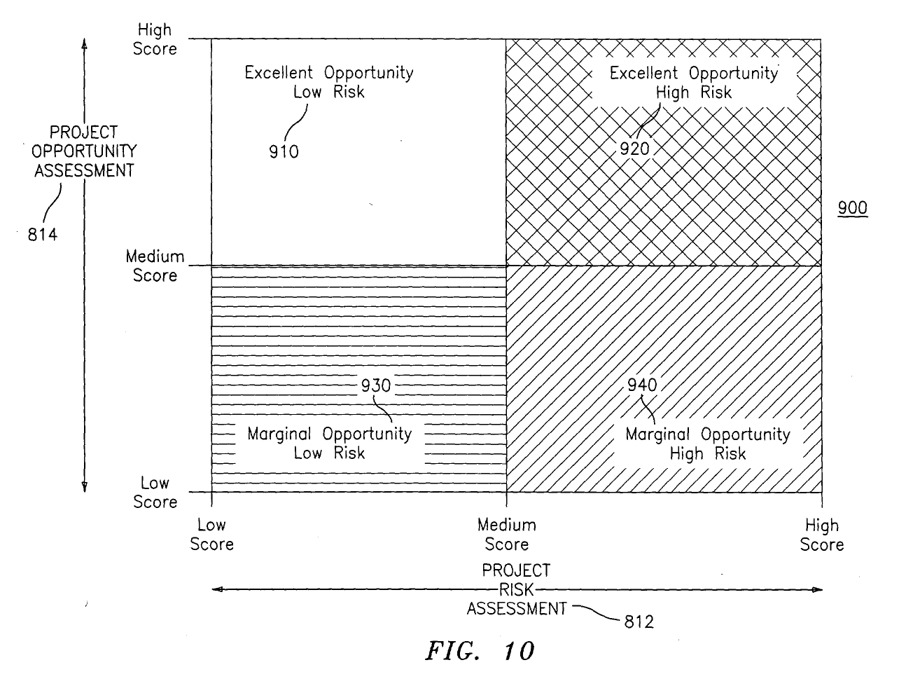

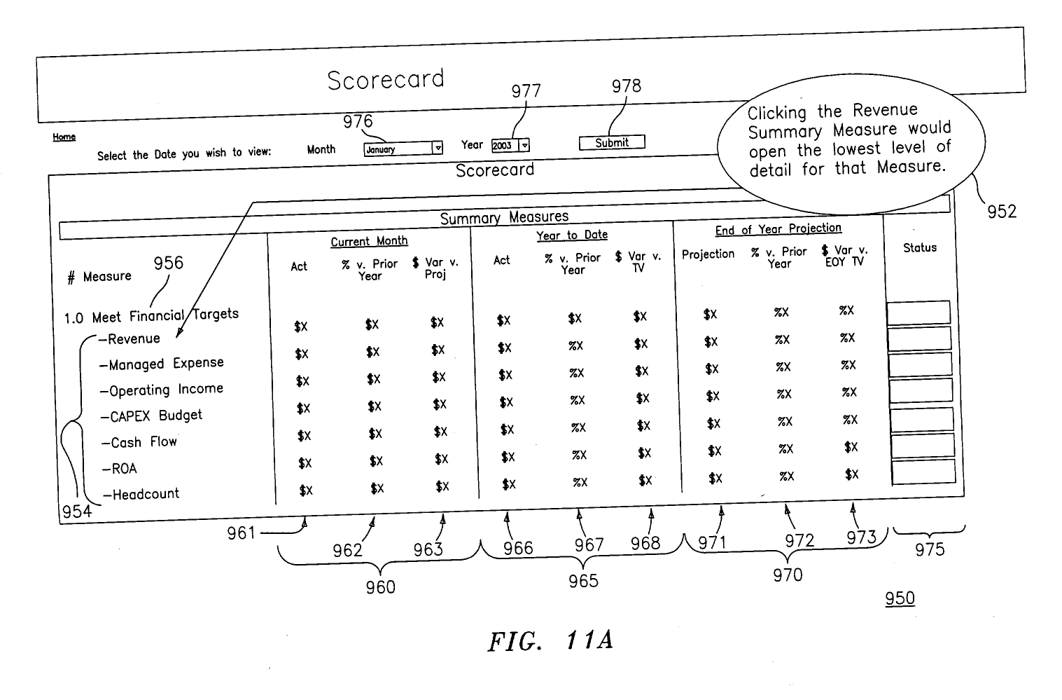

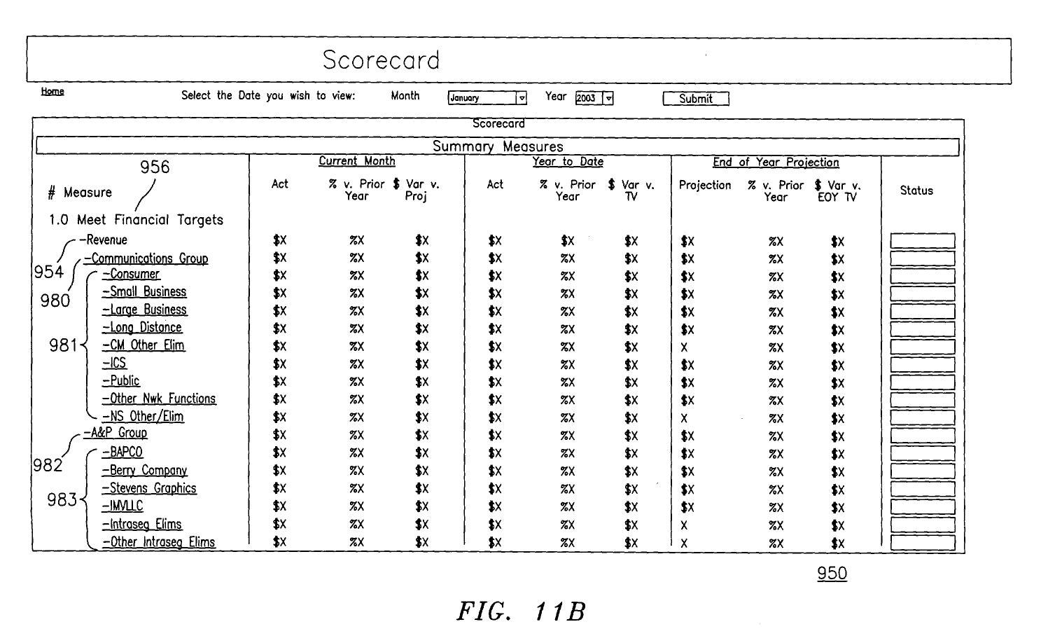

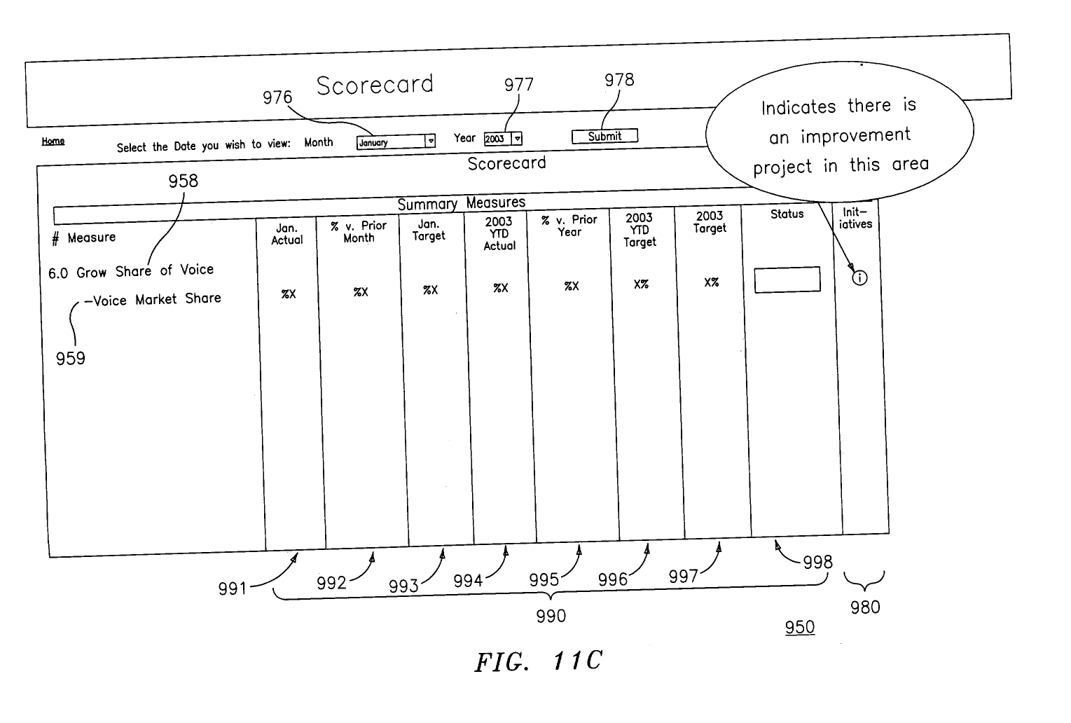

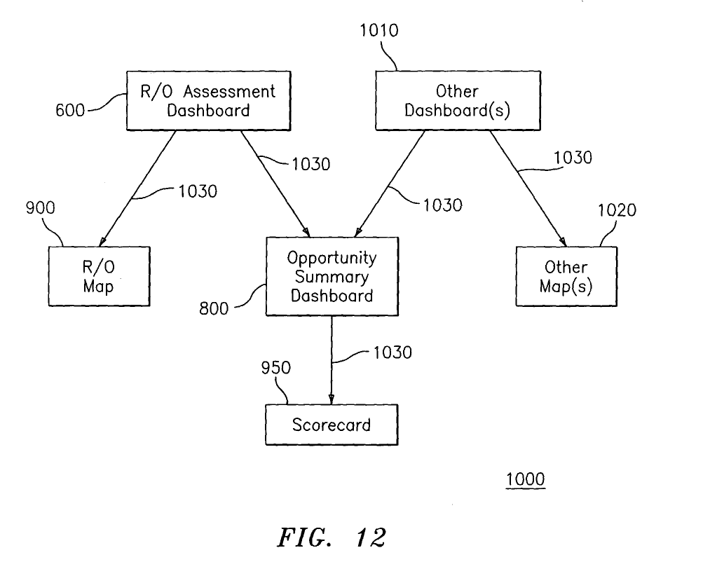

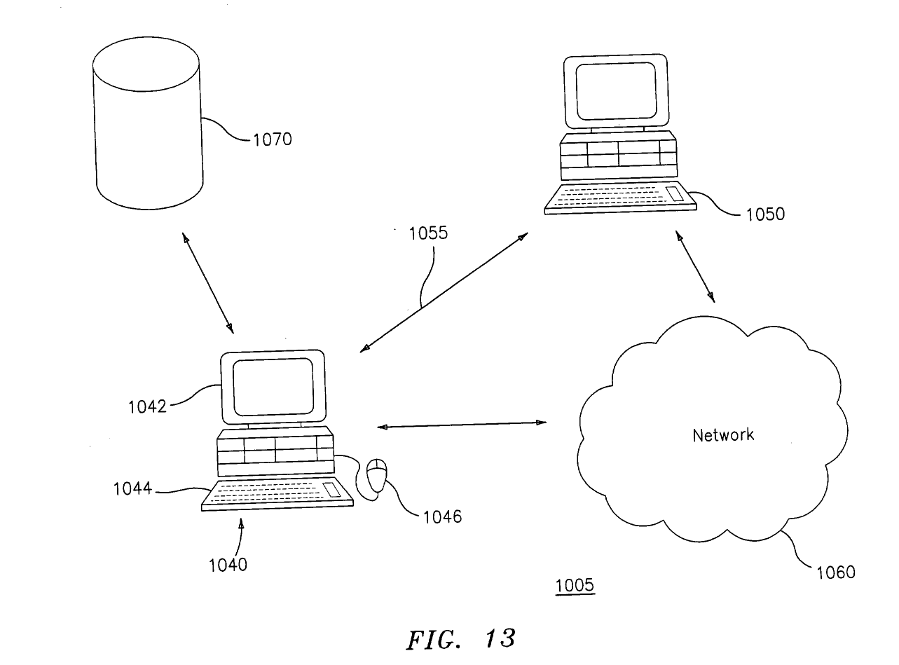

Upon the completion of all entries in dashboard 600, where each column contains entries for a given project title, dashboard 600 calculates the non-financial total scores for each of the risk and opportunity factors for each project, sums these scores with the non-financial total scores from other survey questions in other dashboards (depicted generally as 1010 in FIG. 12 discussed below), and communicates the result to dashboard 800, best seen by now referring to FIG. 9, where the results are entered into the assessment entry blocks 810. Similarly, the dependency responses for each project on dashboard 600 are communicated to the dependency entry blocks 820, and the financial responses to the financial entry blocks 830. The assessment entry blocks 810 are further broken down into feasibility risk assessment score (risk factor) blocks 812, and opportunity assessment score (opportunity factor) blocks 814. The risk factors 812 and opportunity factors 814 are labeled as such in categories 605, 610, 615, 620, 625, 630, 635, 640, 645, and 650 of FIGS. 8A-7E, and noted above. The dependency entry blocks 820 are further broken down into process dependencies 822, system dependencies 824, and organization dependencies 826, which relate to the elements within sub-category 613 in dashboard 600.

The completion of dashboard 600 (and other survey questions in other dashboards 1010) also drives the creation of mapping dashboard 900, best seen by now referring to FIG. 10, (and other mapping dashboards depicted generally as 1020 in FIG. 12 and discussed below), which is produced for each improvement initiative opportunity as designated by project title 700 in dashboards 600, 800. Here, the project risk assessment score 812 is mapped along the x-axis and the project opportunity assessment score 814 is mapped along the y-axis. Dashboard 900 is subdivided into four quadrants: excellent opportunity low risk 910; excellent opportunity high risk 920; marginal opportunity low risk 930; and, marginal opportunity high risk 940. In an exemplary embodiment, a low score is (10), a medium score is (30), and a high score is (50), for both x and y axes.

By utilizing dashboard 600 (and other dashboards 1010) to create dashboards 800 and 900, project managers and business leaders are better equipped to visually review the performance status of any given improvement initiative opportunity at any point in time, and to use this information on a continual basis to make continual decisions regarding the management of the improvement initiatives and the management of sustained process performance within the business.

Once an improvement initiative opportunity has been identified, analyzed and approved for implementation, the financial metrics relating to that initiative are added to a scorecard 950, best seen by now referring to FIGS. 10A-10C, which enables viewing of the financial details at both a high level and a detailed level by mouse-clicking on the appropriate summary measure category box, depicted generally by 952. In an embodiment, the summary measure categories include: revenue; managed expense; operating income; CAPEX (Capital Expenditures) budget; cash flow; ROA (Return On Assets); and, headcount, depicted generally by 954. The summary measure categories may be related to meeting financial targets 956, as depicted in FIG. 11A, or growing market share 958, as depicted in FIG. 11C. Scorecard 950 provides outputs under summary measures, including current month 960, year to date 965, end of year projection 970, and status 975, for example. Status 975 is a high level indicator of performance-to-plan, and is typically depicted as a color, such as green for on-plan, yellow for marginally-on-plan, and red for off-plan, for example. Current month summary measure 960 provides a detailed breakdown showing actual dollars 961, percent variance over prior year 962, and variance dollars projected 963. Year to date summary measure 965 provides a detailed breakdown showing actual dollars 966, percent variance over prior year 967, and variance dollars for TV (Total Variance) 968. End of year projection summary measure 970 provides a detailed breakdown showing projected dollars 971, percent variance over prior year 972, and variance dollars for end of year (EOY) TV 973. Scorecard 950 also enables viewing of the summary measures for a particular month and year by selecting the month 976, year 977, and clicking the submit button 978.

As indicated above, by mouse-clicking on the appropriate summary measure category box, depicted generally by 952, scorecard 950 drives down to a finer level of financial detail, as depicted in FIG. 1I B, which displays the financial details for the revenue summary measure category 954. In an embodiment, the revenue summary measure 954 is broken down by functional groups 980, 982, and functional sub-groups 981, 983. If a particular summary measure category, such as revenue 954 under meet financial targets 956 in FIG. 11A, or voice market share 959 under grow share of voice 958 in FIG. 11C, has an associated improvement initiative project, the association may be displayed on scorecard 950, as indicated by the initiatives indicator 980 in FIG. 11C.

Referring now to FIG. 11C, the grow share of voice (alternatively referred to as growing market share)-summary measure 958 has summary measure outputs 990 that include: monthly actual share 991; percent variance over prior month 992; target for month 993; year to date actual share 994; percent variance over prior year 995; year to date target share 996; target for year 997; and, green-yellow-red status indicator 998.

Scorecard 950 is depicted in FIGS. 10A-10C with defined summary measure categories (depicted generally by 956, 958), defined summary measure outputs (depicted generally by 960, 965, 970, 990), and defined functional groups and sub-groups (depicted generally by 980, 982, and 981, 983). However, the artisan will appreciate that these defined terms are exemplary only and that other terms for another type of business may be used in their place.

The interrelationship between dashboards 600, 1010, mapping dashboards 900, 1020, summary dashboard 800, and scorecard 950, is best seen by now referring to the architecture 1000 depicted in FIG. 12, where communication links are depicted generally by 1030. The blocks denoting other dashboard(s) 1010 and other map(s) 1020, are intended to denote none, one, or more than one other dashboard or map, respectively. As discussed above in reference to dashboard 600, dashboards 600, 1010 provide a starting point for capturing information relating to improvement initiative opportunities. This information is then communicated via communication links 1030 to an opportunity summary dashboard, such as dashboard 800 discussed above, which provides a summary of the assessments, dependencies, and financials associated with each improvement initiative opportunity. The information from dashboards 600, 1010 is also used to generate maps 900, 1020, respectively, which visually depict one aspect of an improvement initiative against another, such as opportunity against risk in map 900 for example. From summary dashboard 800, a scorecard 950 is generated that provides various levels of details relating to defined business interests, such as financials and market share for example. Scorecard 950 includes all business interests, including ongoing activities, previously established improvement initiative opportunities, and newly established improvement initiative opportunities, with the improvement initiative opportunities being identified by initiative identifier 980.

In an embodiment of the invention, architecture 1000 may be implemented on a computer system 1005, best seen by now referring to FIG. 13, which includes at least one computer 1040 that may be connected to another computer 1050 either directly 1055 or over a network 1060. Computer 1050 may be the same as or different from computer 1040. Computer 1040 may be a standalone computer having a display 1042, a keyboard 1044, and a pointing device 1046 such as a mouse for example, or a host computer having a mass storage device 1070, and includes a processing circuit for executing stored instructions. Computer system 1005 includes appropriate application software for generating dashboards 600, 1010, summary dashboard 800, maps 900, 1020, and scorecard 950, collectively referred to as process performance tools, and for providing communication between the process performance tools via architecture 1000. Information contained within the process performance tools may be stored locally on computer 1040 or stored in mass storage device 1070, with the stored information being accessible to other users via direct connection 1055 or network 1060. Network 1060 may be a local area network (LAN), a wide area network (WAN), a global network (for example, Intranet, Extranet, or Internet), or any other network arrangement suitable for implementing the invention. Computer 1040 may be coupled to computer 1050 through multiple networks (e.g., Intranet and Internet) so that not all computers 1050 are required to be coupled to host computer 1040 through the same network. One or more computers 1050 and host computer 1040 may be connected to network 1060 in a wireless fashion and network 1060 may be a wireless network. In an exemplary embodiment, network 1060 is the Internet and each computer 1050 executes a user interface application to directly connect to host computer 1040. In another embodiment, computer 1050 may execute a web browser to contact host computer 1040 through network 1060. Alternatively, computer 1050 may be implemented using a device programmed primarily for accessing network 1060, such as WebTV, for example.

Host computer 1040 may be implemented using a server operating in response to a computer program stored in a storage medium accessible by the server. Host computer 1040 may operate as a network server (often referred to as a web server) to communicate with computer 1050, and may also include a firewall to prevent unauthorized access to the host computer 1040 and enforce any limitations on authorized access. For instance, an administrator may have access to the entire system and have authority to modify portions of the system and a user may only have access to view a subset of the data repository records for particular products. In an exemplary embodiment, the administrator has the ability to add new users, delete users and edit user privileges. The firewall may be implemented using conventional hardware and/or software as is known in the art.

Host computer 1040 may also operate as an application server, which executes one or more application programs to provide access to the data repository located on a mass storage device 1070, as well as application programs to generate and manage the process performance tools. Processing may be shared by computer 1050 and host computer 1040 by providing an application (e.g., java applet) to computer 1050. Alternatively, computer 1050 can include a stand-alone software application for performing a portion of the processing described herein. It is understood that separate servers may be used to implement the network server functions and the application server functions. Alternatively, the network server, firewall and the application server can be implemented by a single server executing computer programs to perform the requisite functions. Mass storage device 1070 may be implemented using a variety of devices for storing electronic information such as a file transfer protocol (FTP) server.

In an exemplary embodiment of the invention, improvement initiative opportunity data is coded using different dashboards, maps and scorecards. Operational leaders, such as DOC 200, C/E-PO 210, SPO 220, and FL 290, for example, use these process performance tools for identifying, rating, ranking, prioritizing, and selecting improvement initiatives to be implemented, and for communicating these decisions on an ongoing basis. By interconnecting these process performance tools over a network, the management of identifying improvement initiative opportunities and sustaining process performance may be conducted at virtual meetings, whereby participants at different locations collectively view and discuss management decisions in real time.

As discussed above, implementation of process 100 is intended to be on a continual basis. As improvement initiative opportunities are identified they are dashboarded, mapped, analyzed and reviewed periodically, typically annually, for implementation consideration. An improvement initiative opportunity that is identified for implementation passes down to the appropriate operational level 200, 210, 220 for further development and management under process 100. Continual review of improvement initiative opportunities, whether identified and implemented or identified and not implemented, under process 100, provides for proactive management, continual process improvement, and sustained process performance.

The following exemplifies how method 10 operates and how each activity interacts with the various governance levels. Method 10 is intended to be exemplary only and not all encompassing, as every company is different in its needs and the order in which to complete the activities. As discussed above, portions of method 10 expand into method 100, which begins with Define Strategy and Key Business Metrics 110 by defining the company strategic direction and the activities that need to be accomplished to achieve that strategy. The strategy and the items needed to achieve that strategy are turned into measurable events or Key Business Metrics (KBM). An example of this might be as follows:

Define Strategy: Meet Financial Objectives, thereby driving a percentage Increase in Revenue.

KBM Activities to achieve Defined Strategy: Develop four new products, thereby delivering a specified number of newly developed products to the customer.

After defining the KBMs, the first piece of the business control structure, which drives sustained process performance, is defined. Here, the DOC 200 develops and populates a dashboard for review and management by the Chief Operations Officer. The dashboard should be populated with the metrics that detail how well the company is achieving its defined strategy. An example of such a dashboard is depicted in FIGS. 11A-11C.

In order to achieve the objectives described in the strategy, the company is typically broken up into manageable components, which typically results in a modified organization structure. Defining the manageable components is accomplished at Define and Establish Core and Enabling Processes 120. At this stage, it is preferable to evaluate the customers the company serves and to create customer-facing processes and processes that directly enable the customer-facing processes.

By way of example, a core process is a strategic focus of the business that specifically accomplishes the mission of the company. The core processes directly contribute to the customer experience or contain activities that require interaction with the customer. The core processes are closely tied to the organizational competencies of the company, and they include the required business processes to define, develop, build, and service the needs of the customer as perceived by the customer. An enabling process is a process that needs to be performed, is enabling to the core process goals, but does not directly serve the customer. Enabling processes support the core processes by providing information, infrastructure, materials and resources. Enabling processes also contain significant customer service and financial implications, but do not directly interact with the customer. A governance process is a process that is performed to manage and govern the business, but does not directly serve the customer. The governance processes enable the core and enabling processes by providing information, methods, materials and resources. With core and enabling processes defined, ownership and responsibility is next assigned and the Process Management Support Team (PMST) defined. Ownership and responsibility is a significant factor in sustaining process performance.

With the PMST defined, the C/E-PO level 210 is positioned to Map the Process 140. This activity begins by estimating where the process both starts and ends, as well as which functional groups/departments are involved in the process. With this knowledge, a rough estimate is made of a sub-process structure 130. This rough estimate breaks the C/E (core/enabling) processes into components that can be more easily mapped and managed. With this rough process structure in place, the PMST assesses which functions play a part in each of the sub-processes. This knowledge is then mapped to a functional analysis, with the functional analysis being used to identify the functional experts.

After completing a functional analysis, the PMST meets with each of the designees from the functions identified. During these meetings, the inputs process and the outputs of each group relative to the C/E process being discussed are reviewed and understood. These meetings may lead to the identification of other functions involved. Any new functions that are identified are added to the analysis and follow up meetings conducted with them. The mapping process is used to set definitive start and stop points in the process. The C/E processes should create a linked arrangement, that is, where one process ends, either the customer has received a service, the information has left the company, or another process is to begin.

Not only do members of the PMST Map the Process 140, but they also Define Process Output Variables 150 by collecting and understanding the customer's requirements of the process. If the process involves a customer-facing process, then the customers are external. However, if the process involves an enabling process, then the customers are internal to the company, such as company employees for example. Process output variables typically come in three distinctly different varieties: KBM, Customer requirements, and Process-to-process variables.

The KBM metrics are derived by understanding the DOC KBM and what part the process plays in achieving that metric. For example, Meet Financial Targets 956 has a metric of percentage increase in revenue. Thus, any process that generates revenue therefore plays a part in achieving that revenue target. The exact amount of revenue to be generated is the KBM for the particular process generating the revenue.

Customer requirements are defined by understanding the customer's need from the process. For example, if a party owns a telephone, the party may expect the telephone to always work. When it does not work, the party would typically like for it to be fixed quickly. This desire would need to be understood in measurable terms. For example, fix quickly might mean that the party wants it fixed within 24 hrs. This customer requirement would be reflected in a metric that says that the Trouble Resolution Time (TRT) for phones out of service should be within 24 hrs. Any time the company misses this customer requirement would result in the company having a negative impact to the percentage of time they meet the customer requirement.

Process-to-Process metrics are used to help processes support one another. For example, for a process that generates revenue, if the process requires that a billing form be correctly filled out in order to bill the customer, then the billing process would be a process-to-process requirement. The metric would be reflected as a percentage of billing submissions filled out correctly.

An understanding of the process and its key outputs enables a governing body to Define and Establish Sub-Processes 130. Each sub-process calls for an owner and some form of a PMST. These individuals are responsible for the outputs of each sub-process, as well as for continuing to refine the process maps and establishing the metrics for the sub-process.

The Sub-Process PMST takes the metrics and maps developed at the C/E level and refines them down to the sub-process level. For example, if a process has three sub-processes and two of these sub-processes work together on the TRT metrics defined earlier, then these two sub-processes each have a part in achieving the customer's requirement of 24 hrs turnaround time. In order to determine the key process output variable at the sub-process level, process maps are reviewed in order to determine how much time each group involved has available to do their part. For example, if the receipt center has 2 hrs and the dispatch center has 3 hours, then the group that goes to the customer premises would have the remainder of the 24 hours. That would mean that at the sub-process level, the sub-process that had receipt of the trouble and dispatch of the trouble could take 5 hrs. Any time they passed 5 hours, would be reflected in their TRT metric. The group that goes to the customer premises has the remainder of the time up to a total of 24 hrs. Breaking up the metric in this manner into sub-processes allows the methodology to focus on the functions that are causing the misses, while leaving the groups performing adequately alone.

With the metrics defined at the sub-process level, the next step is to Define Key Work Activity Output Metrics 160. Here, refined process maps are used, whereby each part of the process map is broken up into related work activities, where each work activity should be able to stand alone as an activity that has a defined output. Here, the term work activity refers to a combination of tasks rather than a defined task. A work activity might be, for example, receive and analyze customer trouble. To determine the metric for the work activity, the metrics, with associated work activities, for each sub-process that allow the sub-process to achieve its objective are strung together. For example, in order to achieve the 5 hr TRT time mentioned earlier, there may be a string of work activities such as: Receive and analyze initial customer trouble; perform secondary analysis of customer trouble; and, dispatch customer trouble. Each work activity would have a distinct metric, and the sum of the metrics would equal the sub-process metric.

It is in the work activity metric that the field performance is measured against the process requirements. From this relationship, an understanding of which functions play a role in which work activity and how each of the functions work together to achieve the process objectives is obtained. The roles of the functions are expressed in terms of metrics, and their relationships are captured in a manner that allows the metrics to be linked from the worker in the field to the C/E process output.

With the metrics and the corresponding owner defined, dashboards are created to allow responsible parties to monitor the performance. Dashboards should be created for C/E Process Owners, Sub-Process Owners and Functional Leaders (that is, from the officers through to the lowest level supervisor). The resulting dashboards display the metrics defined for each individual. At this point in the process-management-building phase, the foundation for continuous improvement has been established. Subsequent to this point in the process, the work is generally related to sustaining process performance or using acquired information to improve upon the company's performance.

The job of the metrics owner as well as the PMST is to Analyze the Process Performance 170. Analysis can take the form of anything from identifying where targets are being missed, to the statistical variation in the performance of individuals in the field. A factor in this analysis is the identification of those areas that need to sustain process performance and those areas that need to improve process performance. This analysis is one of the four defined inputs into Manage and Conduct Improvement initiatives 180.

The PMST not only maps the process and defines the metrics, but also collects data and understands what the functional leaders are already working on as it relates to the process. This event enables the PMST to properly analyze the process by knowing what projects are having an impact on the metrics. A continuously running process facilitates the collection of current and planned projects, which may be captured using a predefined form to identify the improvements and their current status. Other inputs into Manage and Conduct Improvement Initiatives 180 include but are not limited to: Input from the field “Great Ideas”; Internal Audit work; and, Mandated projects (Officer driven or regulatory in nature).

The improvement initiatives are rated, ranked, and selected, based on a predefined utilization of available resources. In order to facilitate the rating, ranking and selecting, a risk and opportunity assessment matrix is used, such as depicted in FIGS. 8A-8E, 9, and 10, and discussed above. Automation of the matrix, as depicted in FIGS. 12-13 and discussed above, enables ranking of projects in order of most favorable to least favorable based on the input numbers.

With the improvements rated and ranked, the functional leaders and sub-process owners work to reach an agreement as to how the limited resources of the company should be focused with respect to the selected projects. Selected projects become active improvement projects, and active improvement projects should be conducted in a manner that is consistent with, and will allow for, composite reporting across the organization. This composite reporting allows for the linking of improvement projects to major output metrics and to track their affect on those metrics.

At the conclusion of an improvement, the next step is to Scale Completed Improvements and Sustain Process Performance 190. Coupled with continuous feedback loops 50, 55 (depicted in FIG. 1), method 100 merges with method 10 to provide the ability to continue to sustain the processes that are performing adequately, to introduce changes from improvement projects based on the processes, and to sustain those improvements. Successful implementation of the methodology of the present invention and its continued success is found in the successful implementation of a business control structure. For the control structure to work, there should be: clearly defined objectives that can be measured (metrics); people accountable for those metrics (process owners and functional leaders); and, a method for regularly reviewing progress against those metrics for which they are accountable (Dashboards). With these attributes, sustaining process performance is achievable. However, if any of the preferred items are absent, optimal performance of the methodology will be difficult.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of managing workflow in a workplace, comprising:
defining a business strategy;
identifying customer needs relating to the business strategy;
defining work elements in response to the customer needs and the business strategy;
determining whether the work elements are to include an improvement initiative;
if an improvement initiative is to be included, then managing and conducting the improvement initiative, and managing the work elements for improved process performance; and
if an improvement initiative is not to be included, then managing the work elements for sustained process performance.

2. The method of claim 1, wherein:
said defining a business strategy comprises:
defining a workplace strategy and associated workplace metrics;
defining and establishing core and enabling processes relating to the strategy and metrics;
defining and establishing subprocesses relating to the core and enabling processes; and
mapping the process relating to the identified subprocesses;
said identifying customer needs comprises defining process output variables relating to the mapped process;
said defining work elements comprises defining work activity output variables relating to the mapped process;
said determining whether the work elements are to include an improvement initiative comprises analyzing process performance of the mapped process; and
said managing and conducting the improvement initiative comprises:
managing and conducting improvement initiatives relating to the mapped process and the defined strategy and metrics; and
scaling the completed improvement initiatives for sustained process performance.

3. The method of claim 1, further comprising:
determining whether a change in business strategy is to be implemented;
if yes, then repeating said defining a business strategy in response to at least one of said managing the work elements for improved process performance and said managing the work elements for sustained process performance; and
if no, then repeating said determining whether the work elements are to include an improvement initiative in response to at least one of said managing the work elements for improved process performance and said managing the work elements for sustained process performance.

4. The method of claim 3, wherein:
said managing and conducting improvement initiatives, further comprises identifying and prioritizing the improvement initiatives; and
said repeating, further comprises repeating said defining a workplace strategy and associated workplace metrics in response to said identifying and prioritizing the improvement initiatives.

5. The method of claim 4, wherein said managing and conducting improvement initiatives comprises:
performing a risk and opportunity assessment analysis for assessing the viability of the improvement initiative opportunities before developing a full project plan and proposal relating to an improvement initiative.

6. The method of claim 5, wherein said performing a risk and opportunity assessment analysis comprises:
completing a questionnaire for subjectively assessing and scoring the risk and opportunity relating to an improvement initiative against a standard set of criteria;
separately calculating and totaling the risk and opportunity scores based on pre-defined impact values; and
mapping the opportunity and risk scores to a matrix subdivided into at least four quadrants for determining the value of an opportunity and indicating the level of associated risk.

7. The method of claim 6, wherein said completing a questionnaire comprises:
selecting a single statement from a set of predefined statements that most accurately depicts the attributes of the improvement initiative.

8. The method of claim 6, wherein said separately calculating and totaling the risk and opportunity scores comprises separately calculating and totaling the risk and opportunity scores from more than one questionnaire.

9. The method of claim 7, wherein said selecting a single statement comprises:
selecting a single statement relating to workplace resource constraints;
selecting a single statement relating to the impact on other workplace processes;
selecting a single statement relating to the quality of the improvement initiative;
selecting a single statement relating to data collection and evaluation;
selecting a single statement relating to geographic considerations;
selecting a single statement relating to the workplace strategy;
selecting a single statement relating to the flexibility of schedule dates; and
selecting a single statement relating to the duration of the improvement initiative.

10. The method of claim 6, wherein said completing a questionnaire comprises:
estimating the pre-completion expense relating to the improvement initiative;
estimating the revenue generation relating to the improvement initiative; and
estimating the cost avoidance relating to the improvement initiative.

11. The method of claim 9, wherein said separately calculating and totaling the risk and opportunity scores based on pre-defined impact values further comprises:
multiplying a probability score relating to each of said single statements with said pre-defined impact value for each of said single statements thereby generating a total score for each of said single statements.

12. The method of claim 5, further comprising:
dashboarding the risk and opportunity assessment analysis against a dependency analysis and a financial analysis.

13. A system for managing workflow in a workplace, comprising:
a workplace strategy and metrics component configured to define and establish a workplace strategy and workplace metrics;
a processes component configured to define and establish core and enabling processes relating to the strategy and metrics;
a subprocesses component configured to define and establish subprocesses relating to the core and enabling processes;
a mapping component configured to map the processes relating to the established subprocesses;
a process output component configured to define and establish process output variables relating to the mapped processes;
a work activity output component configured to define and establish work activity output variables relating to the mapped processes;
an analysis component configured to analyze process performance relating to the mapped processes and to identify at least one of an area to sustain current performance and an area to improve current performance;
a management component configured to manage and conduct actionable initiatives defined by at least one of sustained process performance initiatives and improved performance initiatives relating to the mapped processes and the defined strategy and metrics; and
a scaling component configured to scale at least one of the completed improved performance initiatives and the sustained process performance initiatives.

14. The system of claim 13, wherein said management component is further configured to identify and prioritize the actionable initiatives.

15. The system of claim 14, further comprising:
a feedback loop component configured to feed back the scaled and prioritized actionable initiatives to the workplace strategy and metrics component if a change in business strategy is to be implemented, and to the analysis component if no change in business strategy is to be implemented.

16. The system of claim 15, wherein said management component is further configured to perform a risk and opportunity assessment analysis for assessing the viability of the improvement initiative opportunities before developing a full project plan and proposal relating to an improvement initiative.

17. The system of claim 16, wherein said management component is further configured to:
complete a questionnaire for subjectively assessing and scoring the risk and opportunity relating to an improvement initiative against a standard set of criteria;
separately calculate and total the risk and opportunity scores based on pre-defined impact values; and
map the opportunity and risk scores to a matrix subdivided into at least four quadrants for determining the value of an opportunity and indicating the level of associated risk.

18. A computer program product for continually managing workflow in a workplace and for continually identifying and managing workplace improvement initiatives, the product comprising:
a storage medium, readable by a processing circuit, storing instructions for execution by the processing circuit for:
receiving and displaying improvement initiative opportunity data, including at least one of data relating to a subjective question and data relating to a financial consideration;
storing the improvement initiative opportunity data at a first dashboard;
calculating a score based at least partially on the first dashboard data;
communicating at least one of the score and the data relating to a financial consideration to a second dashboard;
communicating the score to a mapping dashboard and displaying the contents thereof;
displaying the contents of the first and second dashboards; and
communicating at least a portion of the contents of the second dashboard to a scorecard and displaying the contents thereof.

19. The computer program product of claim 18, wherein said storage medium further includes instructions for:
calculating a score at the first dashboard based at least partially on the subjective question and an impact value; and
calculating and displaying at the second dashboard a risk assessment score and an opportunity assessment score.

20. The computer program product of claim 19, wherein said storage medium further includes instructions for:
displaying at the mapping dashboard the opportunity assessment score in relation to the risk assessment score.

21. The computer program product of claim 18, wherein said storage medium further includes instructions for:
displaying at the scorecard financial and market share information relating at least partially to the improvement initiative opportunity data.
